(19) United States
(12) Patent Application Publication
(10) Pub. No.: US 2002/0175454 A1
(43) Pub. Date: Nov. 28, 2002

(54) Shock absorbing device having air envelopes

(76) Inventor: Daniel Huang, Taichung Hsien (TW)

Correspondence Address: CHARLES E. BAXLEY, 5th Floor, 59 John Street, New York, NY, 10038, US

(21) Appl. No.: 10/187,575

(22) Filed: Jul. 3, 2002

Related U.S. Application Data
(63) Continuation-in-part of application No. 09/752,320, filed on Jan. 2, 2001.

(51) Int. Cl. F16F 9/43

(52) U.S. Cl. 267/64.28

(57) ABSTRACT

A shock absorbing device includes a housing having a port formed in an end wall, one or more air envelopes disposed in the housing for cushioning purposes, a tube slidably received in the housing and a piston secured to the tube and slidably engaged in the housing and engageable with the envelope, and a valve engaged in the port of the housing for selectively blocking the port of the housing. A pumping device may be used for selectively pumping air into or out of the housing, such as for pumping air into the housing when either of the air envelopes is broken.

The present invention is a continuation-in-part of U.S. patent application Ser. No. 09/752,320, filed on Jan. 2, 2001, to be abandoned.

### BACKGROUND OF THE INVENTION

1. Field of the Invention

The present invention relates to a shock absorbing device, and more particularly to a shock absorbing device having two or more air envelopes.

2. Description of the Prior Art

Typical shock absorbing devices for objects, such as for vehicles or the like, include a mechanical structure having one or more spring members for cushioning purposes. However, the spring members may have a spring fatigue problem.

The other typical shock absorbing devices comprise having one or more hydraulic cylinders coupled together for cushioning purposes. U.S. Pat. No. 3,726,517 to Lutz, and U.S. Pat. No. 4,880,213 to Shinbori et al. disclose two of the typical shock absorbing devices.

However, the hydraulic fluid may not be compressed and thus include a bad cushioning effect. In addition, once the hydraulic cylinders are broken or have leaking problem, the hydraulic fluid or oil may flow out of the hydraulic cylinders, and the hydraulic cushioning devices will thus become fail.

Particularly, in U.S. Pat. No. 3,726,517 to Lutz, three hydraulic cylinders are coupled together with pipings. However, when either of the hydraulic cylinders is broken or has leaking problem, the hydraulic fluid or oil may flow out of the hydraulic cylinders. The hydraulic cushioning devices do not suggest any devices or facilities to fill or to remove the fluid or oil into and out of the hydraulic cylinders.

U.S. Pat. No. 3,588,064 to Montanari, U.S. Pat. No. 3,738,633 to Pineau, U.S. Pat. No. 4,010,940 to Freyler, and U.S. Pat. No. 4,736,615 to Smedberg et al., disclose the other typical shock absorbing devices having one or more bellows or spheres engaged in a pneumatic cylinder.

However, when one or more of the bellows or spheres are broken, the air may flow out of the cylinders, such that the shock absorbing devices may no longer be provided for cushioning purposes. In addition, the typical cushioning devices do not suggest any devices or facilities to fill or to remove the air into and out of the pneumatic cylinders.

The present invention has arisen to mitigate and/or obviate the afore-described disadvantages of the conventional shock absorbing devices.

### SUMMARY OF THE INVENTION

The primary objective of the present invention is to provide a shock absorbing device having one or more air envelopes for providing the air cushioning effect for the shock absorbing device.

The other objective of the present invention is to provide a shock absorbing device having a check valve provided for preventing the air from flowing out of the shock absorbing device and for allowing the air to be filled into or to be drawn out of the shock absorbing device.

The further objective of the present invention is to provide a shock absorbing device having a device for selectively pumping air into the shock absorbing device.

In accordance with one aspect of the invention, there is provided a shock absorbing device comprising a housing including a chamber formed therein, and including an end wall having a port provided therein, at least one air envelope disposed in the chamber of the housing for cushioning purposes, a tube slidably received in the chamber of the housing, and including a first end having a first piston secured thereto and slidably engaged in the chamber of the housing, and engageable with the envelope, and a valve engaged in the port of the housing for selectively blocking the port of the housing.

A device is further provided for pumping air into and out of the chamber of the housing and includes a casing having a hose selectively coupled to the port of the housing, a second piston slidably received in the casing and movable along the casing to force an air into the housing.

The pumping device includes a cap secured to the casing and having an inner thread formed therein, a pole secured to the second piston and having an outer thread threaded with the inner thread of the cap.

The valve includes a bore formed therein, the hose includes a first end having a nozzle provided thereon for engaging into the bore of the valve. The valve includes a spring blade attached thereto for selectively blocking the bore of the valve and the chamber of the housing.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a cross sectional view of a shock absorbing device in accordance with the present invention;

FIG. 2 is a cross sectional view similar to FIG. 1, illustrating the other embodiment of the shock absorbing device;

FIG. 3 is an enlarged partial cross sectional view showing the check valve of the shock absorbing device; and

FIG. 4 is a cross sectional view illustrating the shock absorbing device and a pumping or the pressure adjusting device for the shock absorbing device.

### DETAILED DESCRIPTION OF THE PREFERRED EMBODIMENT

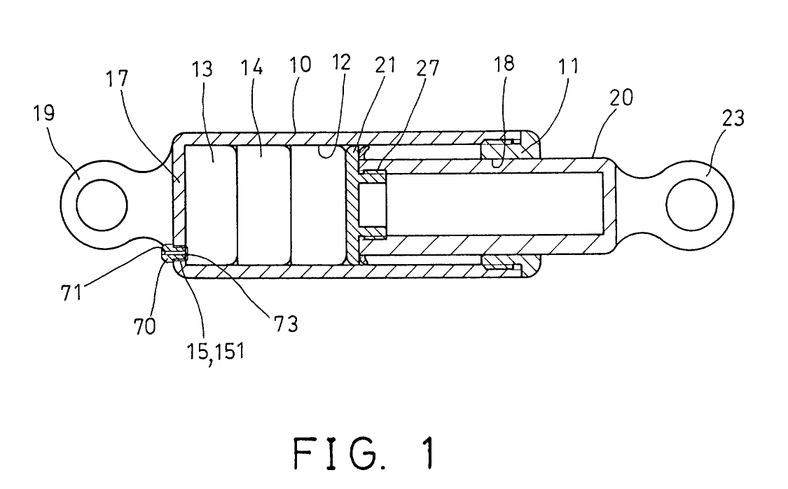

Referring to the drawings, and initially to FIG. 1, a shock absorbing device in accordance with the present invention comprises a housing 10, such as a cylindrical housing 10 having a chamber 12 formed therein for receiving one or more air envelopes 13, 14, and having an end wall 17 provided on one end thereof. The air envelopes 13, 14 may be engaged with or disengaged from the end wall 17 of the housing 10.

A cover 11 may further be provided and threaded to the other end of the housing 10, and includes a bore 18 formed therein. A tube 20 is provided and preferably slidably engaged in the bore 18 of the cover 11, and has one end slidably received in the chamber 12 of the housing 10.

The tube 20 includes a piston 21 secured to the one end thereof with such as a threaded engagement 27, and slidably engaged in the chamber 12 of the housing 10, for engaging with the air envelopes 13, 14, and for allowing the piston 21 to be moved along the chamber 12 of the housing 10 and to be forced to engage with or to be disengaged from the air envelopes 13, 14 by the tube 20.

The housing 10 and the tube 20 each preferably includes a ring 19, 23 provided on one end thereof, and distal to each other, for coupling to the other devices or mechanisms, such as for coupling to two portions of the object, such as the vehicle for cushioning the vehicle.

The air envelopes 13, 14 may be filled with air of different pressures for forming different cushioning effects for the shock absorbing device. The end wall 17 of the housing 10 includes a port 15 having a valve 70, such as a check valve 70 selectively engaged therein for selectively enclosing the chamber 12 of the housing 10.

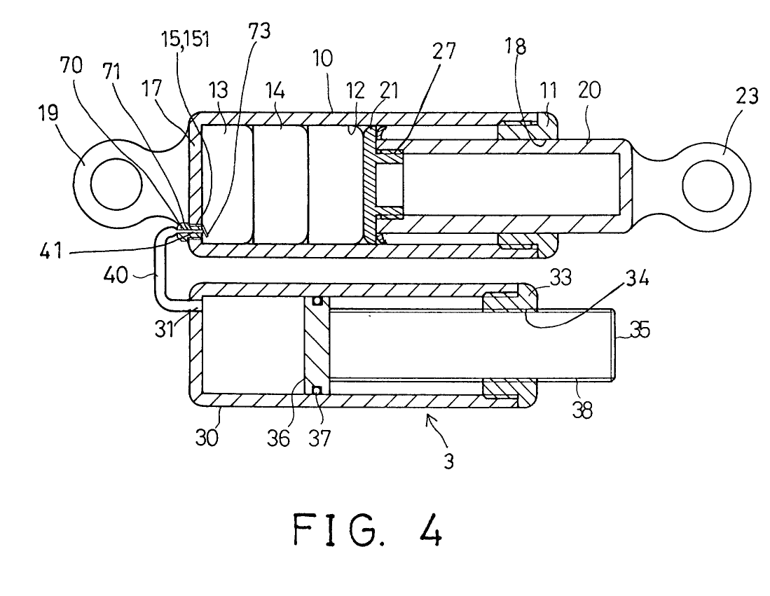

For example, as shown in FIGS. 1 and 4, the valve 70 may be engaged into or secured to the port 15 of the housing 10 with such as a threaded engagement 151, or by fasteners, or by welding processes, and includes a bore 71 formed therein, and a spring blade 73 having one end secured to the inner end of the valve 70 for selectively blocking the bore 71 of the valve 70.

In operation, for example, when either of the air envelopes 13, 14 is broken or damaged, the check valve 70 may block the port 15 of the housing 10, and may prevent the air from flowing out of the housing 10, such that the air retained in the housing 10 may also be used as a cushioning device.

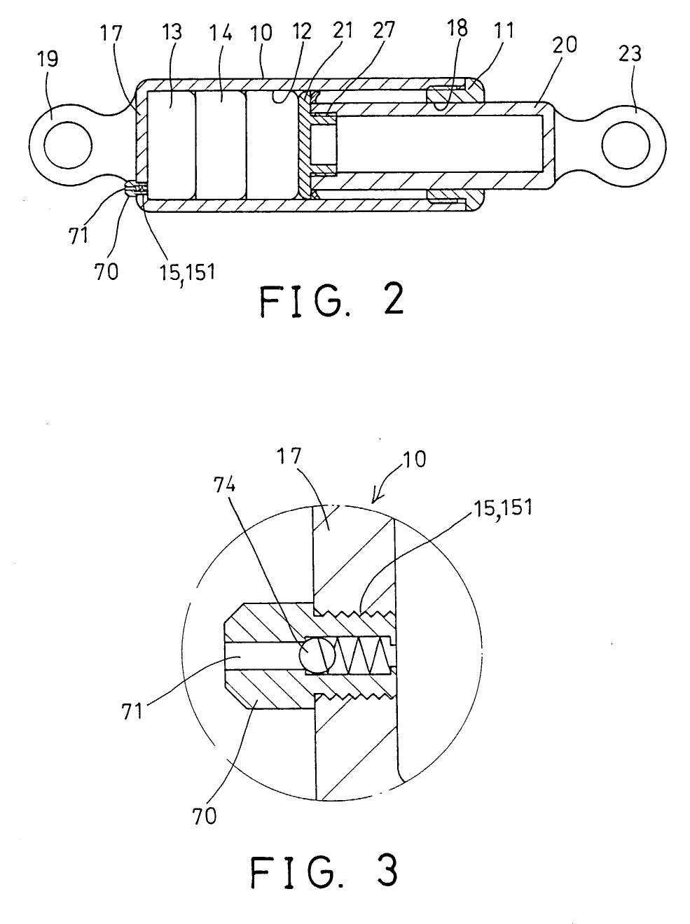

Alternatively, as shown in FIGS. 2 and 3, the check valve 70 may include a spring-biased ball or projection 74 provided in the bore 71 thereof, for selectively blocking the bore 71 thereof, and thus for selectively blocking the port 15 of the housing 10.

As shown in FIG. 4, a pumping means or a pump 3 may further be provided and includes a cylindrical casing 30 having an opening 31 formed in one end thereof for selectively coupling to the port 15 of the housing 10 with a hose 40 or the like. For example, the hose 40 may include a nozzle 41 provided on one end thereof for engaging into the bore 71 of the valve 70 and for opening the spring blade 73.

A cap 33 may be threaded to the other end of the casing 30 and has an inner thread 34 formed therein. A piston 36 is slidably received in the casing 30, a sealing ring 37 is engaged between the piston 36 and the casing 30 for making an air tight seal between the piston 36 and the casing 30.

A pole 35 includes an outer thread 38 formed thereon and threaded with the inner thread 34 of the cap 33 and secured to the piston 36 for moving the piston 36 along the casing 30 by threading or rotating the pole 35 relative to the casing 30.

In operation, the air received in the chamber 12 of the housing 10 and/or the air envelopes 13, 14 may be used to provide a cushioning effect between the housing 10 and the tube 20.

When either of the air envelopes 13, 14 is broken, the air in the housing 10 may also be prevented from being flown out of the housing 10, such that the air retained in the housing 10 by the check valve 70 may also be used for cushioning purposes, at least temporarily.

As shown in FIG. 4, the pump 3 may be used to pump the air into or to draw the air out of the chamber 12 of the housing 10, by moving the piston 36 along the casing 30, when the nozzle 41 of the hose 40 is engaged into the bore 71 of the valve 70 and when the hose 40 couples the pump 3 to the housing 10, in order to adjust the air pressure in the housing 10.

Particularly, when either of the air envelopes 13, 14 is broken, or when the air pressure in the housing 10 is not good enough for providing enough cushioning effect, the cushioning effect to the vehicle may be bad. At this moment, the pump 3 may be used to easily pump air into the housing 10 by the users themselves, for recovering the cushioning effect to the vehicle.

Accordingly, the shock absorbing device in accordance with the present invention includes one or more air envelopes for providing the air cushioning effect for the shock absorbing device, and includes a check valve provided for preventing the air from flowing out of the shock absorbing device and for allowing the air to be selectively filled into or to be drawn out of the shock absorbing device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A shock absorbing device comprising:
a housing including a chamber formed therein, and including an end wall having a port provided therein,
at least one air envelope disposed in said chamber of said housing for cushioning purposes,
a tube slidably received in said chamber of said housing, and including a first end having a first piston secured thereto and slidably engaged in said chamber of said housing, and engageable with said at least one envelope, and
a valve engaged in said port of said housing for selectively blocking said port of said housing.

2. The shock absorbing device according to claim 1 further comprising means for pumping air into and out of said chamber of said housing.

3. The shock absorbing device according to claim 2, wherein said pumping means includes a casing having a hose selectively coupled to said port of said housing, a second piston slidably received in said casing and movable along said casing to force an air into said housing.

4. The shock absorbing device according to claim 3, wherein said pumping means includes a cap secured to said casing and having an inner thread formed therein, a pole secured to said second piston and having an outer thread threaded with said inner thread of said cap.

5. The shock absorbing device according to claim 3, wherein said valve includes a bore formed therein, said hose includes a first end having a nozzle provided thereon for engaging into said bore of said valve.

6. The shock absorbing device according to claim 5, wherein said valve includes a spring blade attached thereto for selectively blocking said bore of said valve and said chamber of said housing.
